(19) United States
(12) Patent Application Publication
(10) Pub. No.: US 2014/0035215 A1
(43) Pub. Date: Feb. 6, 2014

(54) Adjustable Jig for Assembling Spoke Wheel

(71) Applicant: Jeffrey Allen Young, Pocatello, ID (US)

(72) Inventor: Jeffrey Allen Young, Pocatello, ID (US)

(21) Appl. No.: 13/562,844

(22) Filed: Jul. 31, 2012

(51) Int. Cl. B25B 11/02; B25B 11/00

(52) U.S. Cl. 269/90; 269/86; 269/218

(57) ABSTRACT

A for assembling a spoked wheel having a rim, a hub and spokes attaching the rim to the hub includes a base supporting at least three upwardly extending arms terminating is a rim support jaw. The arms pass through eccentric slots in an adjustment plate which is rotationally secured to the base. By rotating the plate relative to the base, the arms are moved radially inward and outward from the rim for both centering it and supporting it so that the spokes and hub are properly positioned and the spokes can be properly tensioned.

### BACKGROUND OF THE INVENTION

1. Field of the Invention

The invention is related to devices for supporting, spoking and aligning the spokes in a spoked wheel and is specifically directed to an adjustable jig for assembling a plurality of different sized spoked wheel rims.

2. Discussion of the Prior Art

Supports, jigs and other devices for supporting the wheel rims for spoked wheels have been available in the art for a number of years.

Most such devices are not self aligning and do support multiple rim diameters without at least partially disassembling the device. One example of such a device is shown in U.S. Pat. No. 3,841,379, issued on Oct. 15, 1974 to Gary W. Kinney. The Kinney patent discloses a device for spoking and aligning wire wheels in which tapered lug supports hold and reference the position of the hub and three or more rim engaging member are indexed to the hub mount concentrically positioning the rim of the wheel alignment with the hub for enabling spokes to be inserted or adjusted.

Other examples of wire wheel assembly tools are also known in the prior art. U.S. Pat. No. 7,178,239, issued on Feb. 20, 2007 to Mario Meggiolan et al discloses a method for manufacturing a bicycle spoked wheel by inserting the nipples or barrels for the attachment of the spikes in the spoke attachment seats from the inside of the spoke attachment chamber instead of from the outside.

U.S. Pat. No. 7,658,450 discloses a method of distributing the spokes in two groups, the first group lacking a tensioning device and the second group having a tensioning device wherein the tension is adjusted and maintained by tensioning only the second group.

### SUMMARY OF THE INVENTION

The subject invention is directed to a jig which is modular in design and may be assembled and disassembled with ease. The base of the jig supports at least three upwardly extending arms terminating is a rim support jaw. The arms pass through eccentric slots in an adjustment plate which is rotationally secured to the base. By rotating the plate relative to the base, the arms are moved radially inward and outward from the rim for both centering it and supporting it so that the spokes and hub are properly positioned and the spokes can be properly tensioned.

In summary, the jig of the subject invention is a device for assembling a spoked wheel having an outer rim, an inner hub, and a plurality of spokes securing the rim to the hub. The jig includes a base, and a plurality of elongated arms mounted in the base. The upper end of each arm includes a jaw for receiving the rim. An adjustment system is adapted for adjusting the position of the arms to the rim and base for properly positioning and securing the rim for assembly of the hub, rim and spokes. A releasable locking system is used for selectively locking and unlocking the arms in position when the rim is properly positioned and secured in the jaws. It is an important feature of the invention that the adjustment system is adapted for moving all of the arms simultaneously as they are adjusted. In the preferred embodiment of the invention the adjustment system a plate which is mounted on the base, with the plate including a series of slots, one for each arm, the slots being shaped and positioned to engage and move the arms radially inward and radially outward as the plate is rotated relative to the base. The releasable locking system is adapted for locking the adjustment system and the arms in position when the rim is properly positioned.

In the preferred embodiment, a single locking knob secures the plate in position relative to the base, and secures the arms in the selected aligned position for supporting the rim.

In additions to the centering and support function of the arms, the plate and base assembly may have a sufficient adjustment range to support more than one diameter rim.

### BRIEF DESCRIPTION OF THE DRAWINGS

FIG. 1 is a perspective view of the assembled jig with a rim in place for installing a hub and spokes.

FIG. 2 is an exploded view of the jig.

FIGS. 3A, 3B and 3C show the top, side and bottom views, respectively, of the base of the jig.

FIGS. 4A, 4B and 4C show the top, side and bottom views, respectively, of the adjustment plate of the jig.

FIGS. 5A, 5B and 5C show a first side, an edge and a second side, respectively, of the rim support arms of the jig.

### DETAILED DESCRIPTION

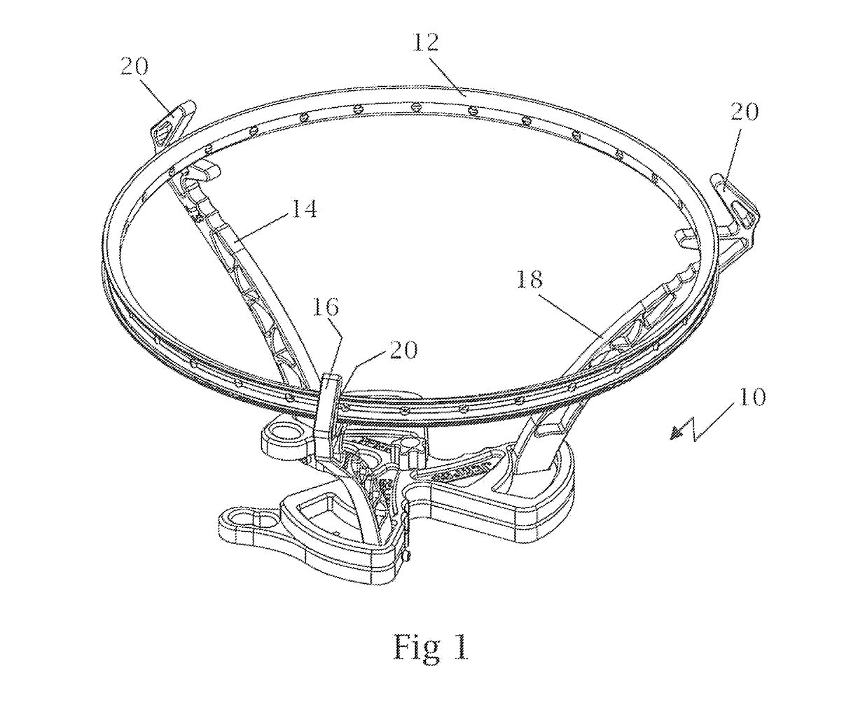

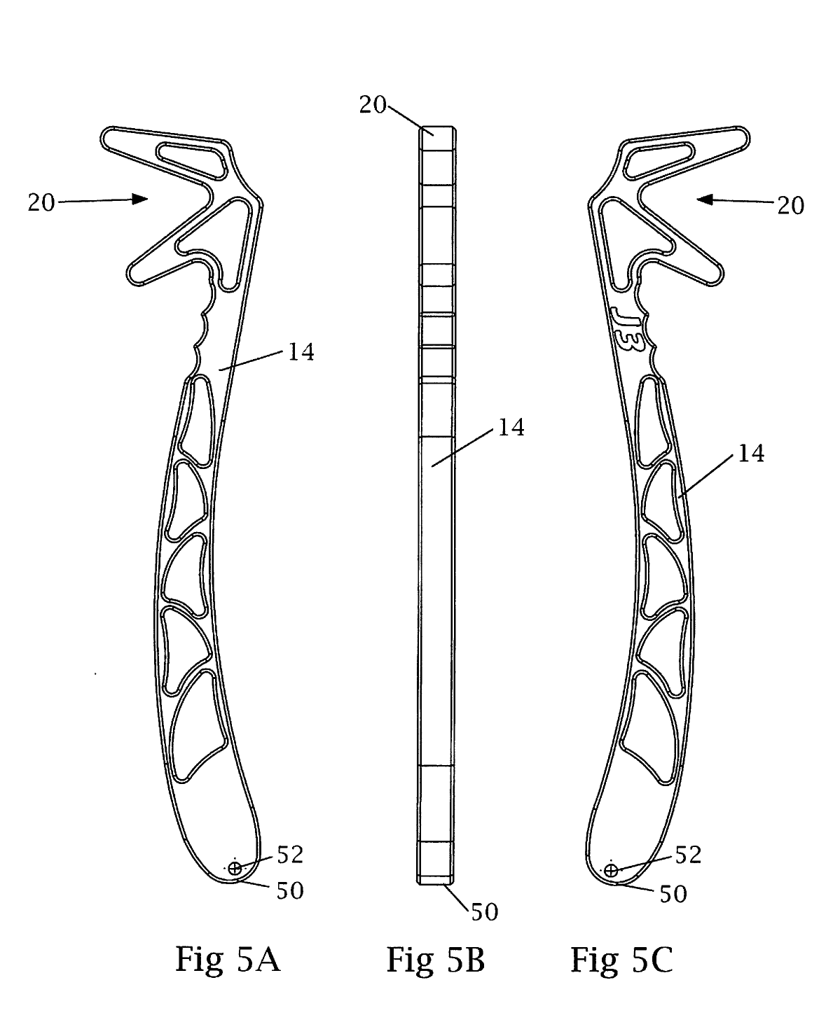

In the broadest sense, and as shown in FIG. 1, the jig 10 of the subject invention is a device for assembling a spoked wheel having an outer rim 12, an inner hub (not shown), and a plurality of spokes (not shown) securing the rim to the hub. The jig includes a base 26, and a plurality of elongated arms 14, 16 and 18 mounted in the base. Each of the elongated arms has lower end 50 (FIG. 5) mounted in the base and an upper end having a jaw 20 for receiving the rim. An adjustment system such as the rotatable plate 32 is adapted for adjusting the position of the arms to the rim and base for properly positioning and securing the rim for assembly of the hub, rim and spokes. A releasable locking system such as the locking knob assembly 34 is used for selectively locking and unlocking the arms in position when the rim is properly positioned and secured in the jaws. It is an important feature of the invention that the adjustment system is adapted for moving all of the arms simultaneously as they are adjusted.

In the preferred embodiment of the invention the adjustment system includes the plate 32 which is mounted on the base 26, with the plate including a series of slots 30, one for each arm 14, 16 and 18, the slots being shaped and positioned to engage and move the arms radially inward and radially outward as the plate is rotated relative to the base. The releasable locking system for locking the adjustment system and the arms in position when the rim is properly positioned and secured includes the locking knob 34 which is threadably received in the base and is in communication with the plate for releasably holding the plate in locked engagement with the base.

The assembled jig 10 is shown in FIG. 1 with a rim 12 in position to be locked in place by the support arms 14, 16 and 18. Typically, a minimum of three arms are utilized to assure self-centering of the rim in the jig. Each arm has a rim supporting jaw 20 which locks the rim in place during spoke and hub assembly process.

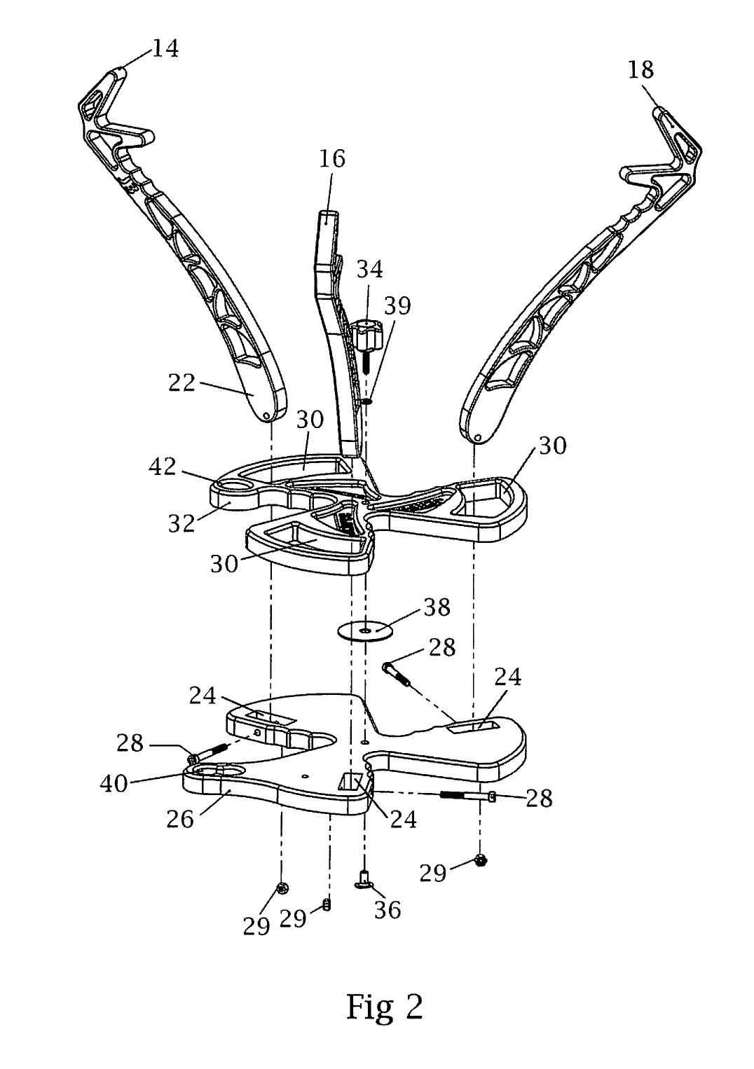

As is better shown in FIG. 2, the lower end 22 of each arm is secured in a receptive slot 24 in the base 26. This may be accomplished by using the threaded bolts 28 with lock nuts 29 or similar fasteners, in the well known manner. It should be noted that each arm is pivotally mounted in the mated slot and each arm may pivot freely about the fastener bolt.

Each arm 14, 16 and 18 passes through one of the eccentric slots 30 in the adjustment plate 32. This permits the arms to be moved radially inward and outwardly relative to the center of the jig by turning the adjustment plate 32 relative to the base 26.

The wheel jig adjustment plate 32 is secured to the base 26 by a lacking knob 34 which passes through the plate and the base and is threadably mounted in an adjustment locking base fastener 36 which is welded or otherwise mounted in the base, or other suitable locking means. A friction washer 38 is positioned between the base 26 and the plate 32 to assure that the plate and the arms are secured in position when the locking knob 34 is locked down. A washer 39 may be positioned between the locking know 34 and the adjustment plate 32. For convenience, an access hole 40 is provided in the base 26 and an access hole 42 is provided in the plate to facilitate holding the base and plate in position as the locking knob is locked down.

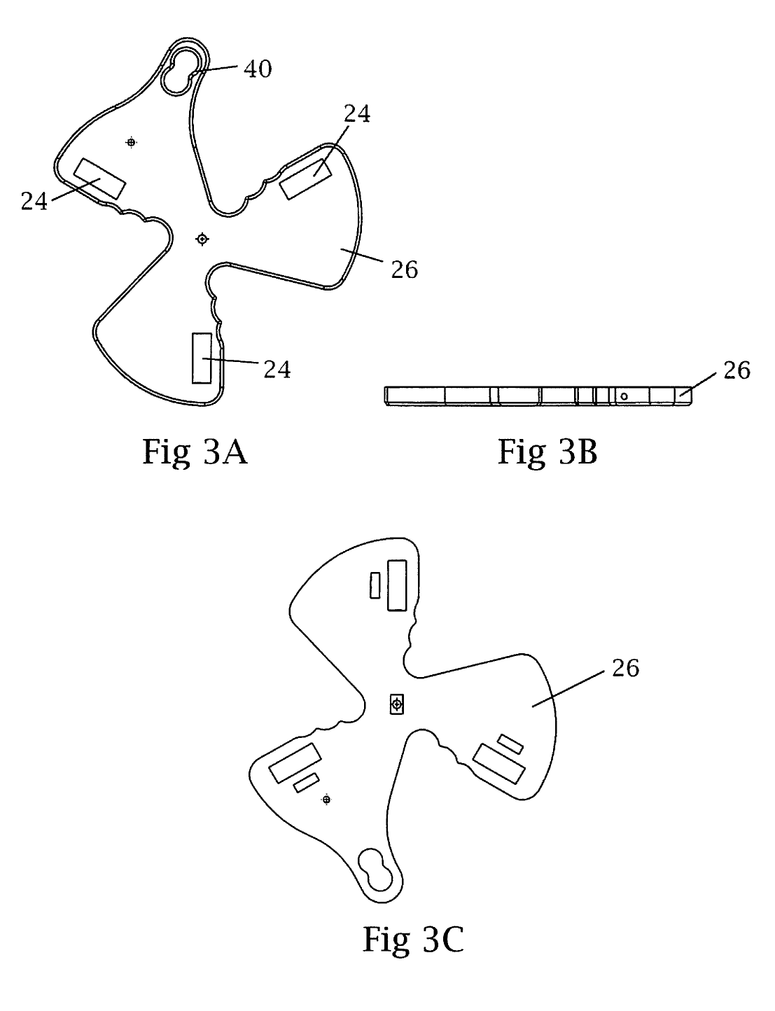

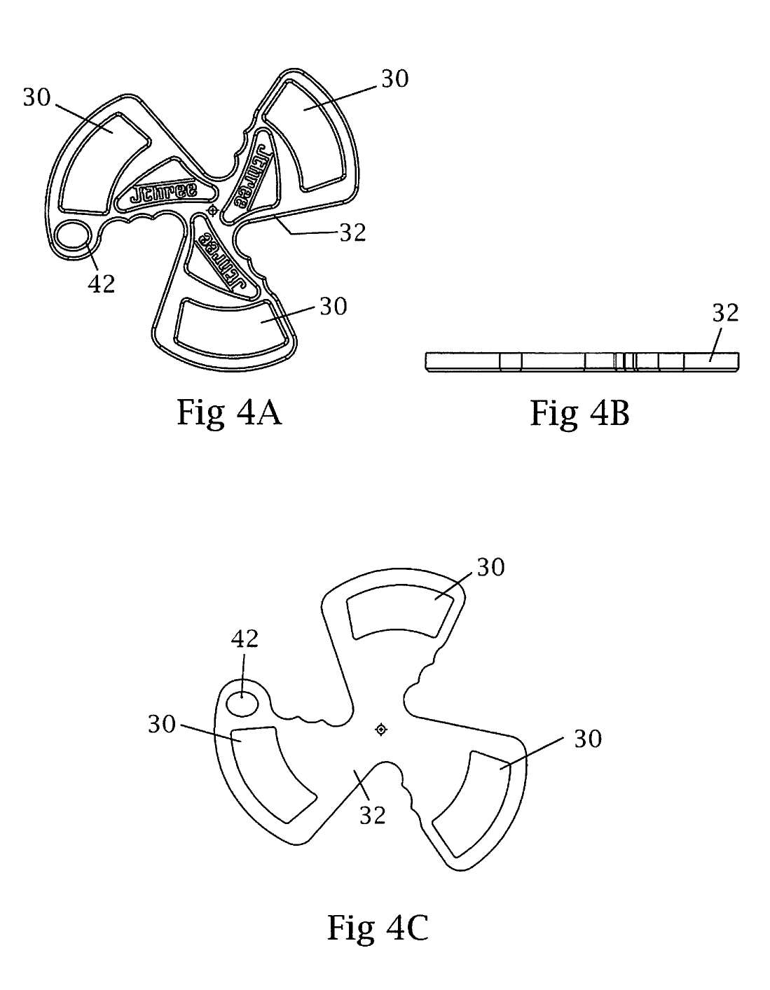

The base 26 is depicted in FIGS. 3A, 3B and 3C. FIG. 3A is the top view of the base. FIG. 3B is the side view of the base. FIG. 3C is the bottom view of the base. Likewise, the adjustment plate 32 is depicted in FIGS. 4A, 4B and 4C. FIG. 4A is the top view of the plate. FIG. 4B is the side view of the plate. FIG. 4C is the bottom view of the plate.

The arms 14, 16 and 18 are identical. FIGS. 5A, 5B and 5C depict a first side, an edge and a second side, respectively, of the arm 14. As there shown, the upper end of the arm terminates in an open, rim receptive, jaw 20. The lower end of the arm is rounded at 50 to permit free pivot of the arm around the fastener 28 which passes through clearance hole 52.

Once the jig is assembled as shown in FIG. 1, the rim 12 is loosely placed in the jaws 20 of the arms 14, 16 and 18. The adjustment plate 32 is then rotated relative to the base 26 and the arms move radially inward due to the positioning of the eccentric slots 30 in the plate. This both secures and centers the rim 12 in the jig by a single motion. Once the rim is positioned secured in place, the locking knob 34 is used to lock the assembly in place for permitting the assembly of a hub and spokes to the rim.

It will be noted that the base slots 24 are circumferentially placed elongated base slots extending radially inward from the outer periphery of the base. The plate slots 30 are in one to one relationship with the base slots, the plate slots extending circumferentially near the outer periphery of the plate. The plurality of arms 14, 16 and 18 each have a lower end 50 mounted to pivot relative to the base, the arms extending through the plate slots, whereby the arms move radially toward and away from the center of the jig when the plate is rotated relative to the base.

The jig of the subject invention provides a convenient and dependable system for assembling spoked wheels. While certain features and embodiments of the jig have been shown and described in detail herein, it should be understood that the invention encompasses all modifications and enhancements within the scope and spirit of the following claims.

What is claimed is:

1. An apparatus for assembling a spoked wheel having an outer rim, an inner hub, and a plurality of spokes securing the rim to the hub, comprising:
a. A base;
b. A plurality of elongated arms mounted in the base, the elongated arms each having a lower end mounted in the base and an upper end having a jaw for receiving the rim;
c. An adjustment system in communication with the arms for adjusting the position of the arms to the rim and base for properly positioning and securing the rim for assembly of the hub, rim and spokes.

2. The apparatus of claim 1, further comprising a releasable locking means for locking the adjustment system and the arms in position when the rim is properly positioned and secured.

3. The apparatus of claim 1, wherein the adjustment system is in communication with the plurality of arms and is adapted for moving all of the arms simultaneously as they are adjusted.

4. The apparatus of claim 3, wherein the adjustment system is a rotatable plate mounted on the base, the plate including a series of slots, one for each arm, the slots being shaped and positioned to engage and move the arms radially inward and radially outward as the plate is rotated relative to the base.

5. The apparatus of claim 1, further comprising a releasable locking means for locking the adjustment system and the arms in position when the rim is properly positioned and secured.

6. The apparatus of claim 5, including a locking knob threadably received in the base and in communication with the plate for releasably holding the plate in locked engagement with the base.

7. A jig adapted for holding a wheel rim during assembly of a spoked wheel, the jig comprising:
a. A base having a plurality of circumferentially placed elongated base slots extending radially inward from the outer periphery of the base;
b. A plate having plate slots in one to one relationship with the base slots, the plate slots extending circumferentially near the outer periphery of the plate;
c. A plurality of arms having a lower end mounted to pivot relative to the base, the arms extending through the plate slots, whereby the arms move radially toward and away from the center of the jig when the plate is rotated relative to the base;
d. A rim receptive jaw at an upper end of each arm, whereby the jaws are tightened and loosened relative to the rim as the plate is rotated.

8. The jig of claim 7, further comprising a locking system for locking the plate and the base in selected position relative to one another.
